(19) United States
(12) Patent Application Publication
(10) Pub. No.: US 2026/0050156 A1
(43) Pub. Date: Feb. 19, 2026

(54) MULTI-AXIS MICROSCANNER SYSTEM, AND METHOD AND APPARATUS FOR CONTROLLING THE DRIVE THEREOF

(71) Applicant: OQMENTED GMBH, Itzehoe (DE)

(72) Inventor: Felix Christoph TIEDE, Hamburg (DE)

(21) Appl. No.: 19/101,480

(22) PCT Filed: Jul. 26, 2023
(86) PCT No.: PCT/EP2023/070764

§ 371 Date: Feb. 5, 2025

(30) Foreign Application Priority Data
Aug. 8, 2022 (DE) 10 2022 119 915.0

(51) Int. Cl. G02B 26/12; G02B 26/08; G03B 21/00

(52) U.S. Cl. CPC G02B 26/127; G02B 26/085; G03B 21/008

(57) ABSTRACT

A method for controlling a drive for a multi-axis, in particular two-axis, micro-scanner system. As part of the method, a drive device for the micro-scanner system is controlled in such a way that the micro-scanner system is thereby caused to perform a first rotational oscillation of a deflection element of the micro-scanner system about a first oscillation axis by means of excitation at a first drive frequency and, simultaneously with the first oscillation, a second rotational oscillation of a deflection element of the micro-scanner system about a second oscillation axis which is not parallel to the first oscillation axis, in particular orthogonal thereto, by means of excitation at a second drive frequency, wherein these drive frequencies are respectively varied in time. The drive frequencies are varied over time in such a way that a change in the frequency ratio between the two drive frequencies is counteracted at the same time. While the drive frequencies themselves change, a change in the frequency ratio is counteracted.

The present invention relates to a multi-axis, in particular two-axis, micro-scanner system as well as a method, a device and a computer program (product) for controlling a drive of such a micro-scanner system.

Micro-scanners, which are also referred to in technical terms in particular as “MEMS scanners”, “MEMS mirrors”, or “micromirrors”, or in English in particular as “micro-scanner” or “micro-scanning mirror” or “MEMS mirror”, are micro-electro-mechanical systems (MEMS) or more specifically micro-opto-electro-mechanical systems (MOEMS) from the class of micromirror actuators for dynamic modulation of electromagnetic radiation, in particular of visible light. Depending on the design, the modulating movement of an individual mirror can be translational or rotational around at least one axis. In the first case, a phase-shifting effect is achieved, and in the second case, the deflection of the incident electromagnetic radiation is achieved. Micro-scanners are also considered, in which the modulating movement of an individual mirror is, at least also, rotational. In micro-scanners, the modulation is typically generated via a single mirror for each MEMS-element (micro-scanner), in contrast to mirror arrays, in which the modulation of incident light occurs via the interaction of multiple mirrors on a single MEMS-element.

Micro-scanners may thus be used in particular to deflect electromagnetic radiation in order to modulate an electromagnetic beam incident thereon with respect to its deflection direction by means of a deflection element (“mirror”). This can be used in particular to achieve a Lissajous projection of the beam into an observation field or projection field. For example, imaging sensory tasks can thus be achieved or display functionalities can be implemented. In addition, such micro-scanners can also be used to irradiate materials in an advantageous manner and thus also process them. Other possible applications are in the area of lighting or illuminating certain open or closed spaces or areas of spaces using electromagnetic radiation, for example in the context of headlight applications.

In many cases, micro-scanners consist of a mirror plate (deflection plate) that is suspended laterally on elastically stretchable springs. A distinction is made between single-axis mirrors, which should preferably only be suspended so as to be rotatable about a single axis, and two-axis and multi-axis mirrors, in which rotations, in particular rotational oscillations, are possible about a corresponding number of different axes, in particular simultaneously.

A micro-scanner system for deflecting an electromagnetic beam can thus in particular have a two-axis micro-scanner, i.e. a micro-scanner with two different, non parallel, in particular mutually orthogonal, oscillation axes or a combination of multiple individual, in particular two, single-axis micro-scanners, which are arranged such that the incident beam can be deflected in succession by the various individual micro-scanners of the micro-scanner system, in order to generate a bi-dimensional deflection pattern, in particular a Lissajous figure. In a micro-scanner system with a combination of two or three single-axis micro-scanners, their non parallel oscillation axes can be orthogonal to each other, particularly in pairs.

Both in the case of imaging sensors and in the case of a display function, a micro-scanner is used to deflect electromagnetic radiation such as a laser beam or a shaped beam from any other source of electromagnetic radiation at least in two dimensions, for example horizontally and vertically, in order to thus scan or illuminate an object surface within an observation field. In particular, this can be done in such a way that the scanned laser beam sweeps over a rectangular surface on a projection surface in the projection field. In these applications, micro-scanner systems having at least one two-axis micro-scanner or having multiple, in particular two, single-axis micro-scanners connected in succession in the optical path are used. The wavelength range of the radiation to be deflected can in principle be selected from the entire spectrum of short-wave UV radiation, through the VIS range, NIR range, IR range, FIR range up to long-wave Terahertz and radar radiation.

Especially in so-called Lissajous micro-scanners or Lissajous micro-scanner systems, two non-parallel, in particular mutually orthogonal oscillation axes are operated simultaneously, in particular in resonance, in order to generate a trajectory of the deflected radiation in the form of a Lissajous figure. In this way, large amplitudes can be achieved in both axes.

A deflection device for a projection system for projecting Lissajous figures onto an observation field is known from EP 2 514 211 B1, which device is designed to deflect a light beam around at least a first and a second deflection axis to generate Lissajous figures.

The object of the present invention is to further improve the operation of Lissajous micro-scanners with regard to applications in the field of projection displays, in particular with regard to ensuring the achievement of high image quality for illumination of the observation field.

This object is achieved according to the teaching of the independent claims. Various embodiments and developments of the invention are the subject matter of the dependent claims.

A first aspect of the solution presented here concerns a method for controlling a drive for a multi-axis, in particular two-axis, micro-scanner system. As part of the method, a drive device for the micro-scanner system is controlled (i.e. suitable control signals are generated and output for this purpose) in such a way that the micro-scanner system is thereby caused to perform a first rotational oscillation of a deflection element of the micro-scanner system about a first oscillation axis by means of excitation at a first drive frequency and, simultaneously with the first oscillation, a second rotational oscillation of a deflection element of the micro-scanner system about a second oscillation axis which is not parallel to the first oscillation axis, in particular orthogonal thereto, by means of excitation at a second drive frequency, wherein these drive frequencies are respectively varied in time. The drive frequencies are varied over time in such a way that a change in the frequency ratio between the two drive frequencies is counteracted at the same time. While the drive frequencies themselves thus change, a change in the frequency ratio is counteracted.

A “deflection element” (and variations thereof) as defined herein is understood in particular as a body which has a reflective surface (mirror surface) that is smooth enough that electromagnetic radiation, such as visible light, reflected on the mirror surface, retains its parallelism under the law of reflection and thus allows an image to be reproduced. The roughness of the mirror surface has to be less than approximately half the wavelength of the electromagnetic radiation. The deflection element can in particular be designed as a mirror plate having at least one mirror surface or can include such a mirror plate. In particular, the mirror surface itself can consist of a different material, for example of a metal, which is in particular deposited (such as by chemical vapor deposition (CVD) or sputtering), than the rest of the body of the deflection element. In the aforementioned micro-scanner system according to the solution, the first oscillation and the second oscillation can either refer to a same, thus multi-axis, deflection element of the micro-scanner system, or to different deflection elements arranged in a same beam path, in particular deflection elements of single-axis micro-scanners of the micro-scanner system.

A “Lissajous projection” (and variations thereof) as defined herein is to be understood in particular as scanning of an observation field with the aid of electromagnetic radiation, which is achieved by at least two mutually non parallel, in particular mutually orthogonal sinusoidal oscillations of a deflection device deflecting the radiation into the field of observation, in particular of an at least two-axis micro-scanner system.

The term “axis” or, equivalently, “axis of oscillation” (and variations thereof), as used herein, means an axis of rotation (rotation axis) of a rotational movement, in particular an oscillating rotational movement. It is thus a straight line that defines or describes a rotation or twisting.

The term “drive device” (and modifications thereof), as used herein, is to be understood in particular as a device which has one or more actuators for driving the oscillatory movements of one or more deflection elements of a micro-scanner system. In the case of a micro-scanner system with multiple micro-scanners, a drive device can also be understood in particular as a device which has one or more actuators for driving the respective deflection units of these micro-scanners.

As possibly used herein, the terms “comprises,” “contains,” “includes,” “includes,” “has,” “with,” or any other variant thereof are intended to cover non-exclusive inclusion. For example, a method or a device that comprises or has a list of elements is not necessarily restricted to these elements, but may include other elements that are not expressly listed or that are inherent to such a method or such a device.

Furthermore, unless expressly stated to the contrary, “or” refers to an inclusive or and not to an exclusive “or”. For example, a condition A or B is met by one of the following conditions: A is true (or present) and B is false (or absent), A is false (or absent) and B is true (or present), and both A and B are true (or present).

The terms “a” or “an” as used herein, are defined in the meaning of “one or more”. The terms “another” and “a further” and any other variant thereof are to be understood to mean “at least one other”.

The term “plurality” as possibly used herein is to be understood to mean “two or more”.

The term “configured” or “set up” to perform a specific function (and respective modifications thereof), possibly used herein, is to be understood to mean that the corresponding device or component thereof is already provided in a design or setting in which it can execute the function or that it is at least adjustable—namely configurable—so that it can execute the function after corresponding adjustment. The configuration can take place, for example, via a corresponding setting of parameters of a process course or of switches or the like for activating or deactivating functionalities or settings. In particular, the device can have multiple predetermined configurations or operating modes, so that the configuration can be carried out by selecting one of these configurations or operating modes.

When multi-axis micro-scanner systems are used for image projection with Lissajous figures, the achievable image quality is largely determined by the ratio of the two oscillation frequencies. Even small changes in this ratio can lead to noticeable disturbances in the projection image, such as flickering of the image or poor coverage or line density, in particular image gaps.

If the drive frequencies of the two oscillations are detuned independently of each other (e.g. to compensate for temperature fluctuations or other disturbances), the frequency ratio will inevitably fluctuate. This is especially the case in regulated (closed-loop) operation.

The method according to the first aspect solves this problem by controlling the various oscillations in such a way that the temporal variation (detuning) of their drive frequencies occurs in such a way that at the same time a change in the frequency ratio between the two drive frequencies is counteracted. The frequency ratio is therefore changed as little as possible, even if the drive frequencies themselves are detuned.

The drive frequencies can therefore only be detuned in dependence on one another in such a way that the frequency ratio is changed as little as possible, i.e. it is stabilized. In the steady state of the oscillations, essentially the same Lissajous figure, determined by the frequency ratio, is always followed as the trajectory of the deflected radiation. If the drive frequencies are now increased or decreased (e.g. to compensate for temperature fluctuations and the resulting changes in the resonance frequencies of the deflection element or elements of the micro-scanner system), the shape of the Lissajous figure remains, at least essentially, preserved. Only the speed at which the figure is followed changes slightly. This makes it possible to achieve and maintain a uniform, particularly low-flicker and stable, and thus high-quality projection, namely a high image quality, even over a longer observation period.

Various preferred exemplary embodiments of the method are initially described hereinafter, which in each case, unless expressly excluded or technically impossible, can be combined as desired with one another and with other aspects of the present solution, which will be described in the following.

In some embodiments, the frequency ratio is a variable that can be set by means of at least one parameterization of the controller, and the method further comprises setting this variable to a target value. In this way, the setting allows selecting a desired Lissajous figure from a variety of different options. This makes it possible, in particular, to make an optimized selection depending on the application or situation.

In particular, according to some of these embodiments, the setting of this variable to a target value can be done while the oscillations are driven by the drive device. This even allows a dynamic selection of Lissajous figures during operation of the micro-scanner, i.e. a dynamic change of figures. In particular, this can also be done automatically according to a predetermined scheme that defines a temporal sequence of different settings.

In some embodiments, the counteraction against a change in the frequency ratio between the two drive frequencies, at least in a steady state of the two oscillations, is carried out in such a way that the frequency ratio is kept in a range of ±1%, in particular in a range of ±0.01%, and preferably in a range of ±0.001%, of its initial value at the beginning of the temporal variation of the drive frequencies, in particular by a correspondingly set regulation. In this way, a high stability of the resulting Lissajous figure can be achieved in order to achieve a particularly high image quality for the illumination of the observation field.

The term “steady state” as used here is to be understood in particular as a state of an oscillatory system, here the micro-scanner system or its at least one deflection element, after an external excitation or in the case of a continuing external excitation, in which the state variables amplitude, frequency and phase (i) of the oscillatory system (in particular in each case related to the angular position with respect to the respective oscillation axis of the at least one deflection element), (ii) with continued excitation also of the excitation signal, become at least approximately constant.

In some embodiments, controlling the drive device comprises regulating the oscillations, wherein the temporal variation of the drive frequencies is carried out in such a way that at the same time, by means of the regulation, a change in the frequency ratio between the two drive frequencies is counteracted. In this way, a high stability of the resulting Lissajous figure can be achieved in order to achieve a particularly high image quality for the illumination of the observation field, even if the state parameters of the oscillation and thus also the resulting Lissajous figure would change without regulation. As a rule, for example, the resonance frequencies of the deflection element(s) of the micro-scanner system are in particular temperature-dependent, so that the drive frequencies for the oscillation axes can be adjusted using the regulation in order to maintain the intended frequency ratio between the drive frequencies.

In some of these embodiments, a controlled variable is used for the regulation, which variable (i) depends both on a first sensor-detected value of at least one physical variable which is in a dependency relationship with a resonance frequency of the first oscillation axis, (ii) and on a second sensor-detected value of at least one second physical variable which is in a dependency relationship with a resonance frequency of the second oscillation axis. Thus, a regulation variable is taken into account for the regulation and affects both oscillation axes, whereby the frequency ratio of the drive frequencies can be maintained particularly effectively and with high dynamics and low latency.

The term “dependence relationship” between two variables (and variations thereof), as used herein, means that at least one of the two variables depends on the other variable. The dependency can be expressed in particular in the sense of a mathematical function or more generally in the sense of a relation or correlation. What is crucial in this case is that a resonance frequency dependent on the measured value of the at least one variable can be deduced from the same. The dependence can be unilateral or mutual.

In some embodiments, the physical variable characterizes or depends on one of the following states of the micro-scanner system (in particular a portion or component thereof) or a combination of at least two of these states or state changes: (i) a shift in a measured resonance frequency of at least one of the oscillations; (ii) a temperature; (iii) a mechanical stress or strain; (iv) an oscillation amplitude of the or a deflection element; (v) a phase instability occurring in at least one of the oscillations; (vi) an exceeding of the respective control variable of a phase-locked loop for the phase of at least one of the oscillations; (vii) a phase difference between a drive signal for controlling the drive device and a measurement signal that represents a measured deflection of the deflection element; (viii) a change in the incident electromagnetic radiation power that the deflection element acquires by absorption; (ix) an oscillation state of a reference oscillator in the micro-scanner system, or its change, wherein the oscillation state of the reference oscillator or its change correlates with an oscillation state of the or of the at least one deflection element or its change, in particular in a certain dependency relationship. Thus, for example after a prior calibration, the detected oscillation state of the reference oscillator or its change can be used to infer the oscillation state of the or at least one deflection element or its change. The oscillation state can be, in particular, an amplitude, a frequency and/or a phase of the respective oscillation or a combination of two or more of these variables.

What all these states or changes in state have in common is that, on the one hand, they can be easily detected by sensors and, on the other hand, they are dependent on the current resonance frequencies of the micro-scanner system and are therefore suitable as an input variable for controlling the drive frequency or drive frequencies.

In some embodiments, the regulation variable is determined by averaging the first physical variable and the second physical variable as input variables (for averaging). On the one hand, this is particularly easy to implement and, on the other hand, it provides good and symmetrical regulation quality with respect to both oscillation axes.

In some embodiments, the regulation variable is determined based on a bad point regulation with respect to the first physical variable and the second physical variable as input variables (for the bad point regulation). The term “bad point regulation”, as used here, refers in particular to a regulation in which the more critical of the two physical variables for achieving good reference behavior of the regulation serves as the reference variable. In particular, the phase of the axis that is most at risk of falling out of resonance can be regulated accordingly.

In some embodiments, the method comprises: (i) a first method mode in which the drive device is controlled such that the first oscillation and the second oscillation are controlled independently of one another, in particular phase-controlled; and (ii) a second method mode in which the drive device is controlled, as described above, such that the regulation involves the temporal variation of the drive frequencies in such a way that a change in the frequency ratio between the two drive frequencies is simultaneously counteracted. In the method, switching between the two method modes takes place. Switching can be done from the first method mode to the second method mode and/or vice versa. In particular, multiple switching is also conceivable.

In some of these embodiments, the first method mode is used to start the oscillations from a resting state or when an occurrence of a disturbance of at least one of the oscillations has been detected, and the switching from the first method mode to the second method mode takes place when it is subsequently detected that the two oscillations are in a respective steady state. In this way, the oscillation can be brought into the steady state quickly and in particular in such a way that the respective drive frequency of each of the oscillations is brought at least approximately to the resonance frequency of the associated oscillation. The Lissajous figure, which has been set in this way via the frequency ratio of the current resonance frequencies, is then maintained by adjusting the drive frequencies accordingly as the resonance frequencies change, but maintaining the frequency ratio. The steady state can be detected in particular by measuring the respective oscillation amplitude of at least one of the oscillations, in particular in such a way that the steady state is detected as such when the amplitude is recognized as stable according to a predefined stability criterion, e.g. when it remains within a predefined fluctuation range.

In some embodiments, the deflection element of the micro-scanner system forms a non-linear oscillator with respect to at least one of its oscillation axes, in particular a Duffing oscillator or an oscillator that can be described to a good approximation as a Duffing oscillator (such as with a maximum 5% amplitude deviation compared to an optimally approximated ideal Duffing oscillator). The temporal variation of the drive frequencies is carried out in such a way that a change in the frequency ratio between the two drive frequencies is counteracted in such a way that the frequency ratio is kept in a certain frequency ratio range, wherein the frequency range of the respective drive frequencies is below a frequency of the respective non-linear oscillator at which it reaches a maximum amplitude as the drive frequency increases. A lower limit of this frequency range can be in particular at the resonance frequency of the nonlinear oscillator (in free oscillation).

This ensures that the advantages of a non-linear oscillator, in particular with regard to high amplitude and phase stability against fluctuations or shifts in the drive frequency or resonance frequency, in particular due to temperature, can be used, while hysteresis-related, undesirable amplitude and/or phase jumps, such as can occur at certain jump points in non-linear oscillators showing hysteresis, are avoided.

A second aspect of the present solution relates to a control device for controlling a drive for a multi-axis micro-scanner system, wherein the control device is configured to carry out the method according to the first aspect, in particular according to one or more of the embodiments described herein.

The term “control device” as used herein is to be understood in particular as a device, in particular a so-called “embedded system”, which is suitable for integration into a micro-scanner system and is designed to control a drive, in particular a drive device, for a multi-axis micro-scanner system in the sense of control or regulation via corresponding signals. In particular, the control device can also have signal or data inputs in order to be able to receive, for example, sensor signals or data from sensors or other components of the micro scanner system.

In some embodiments of the control device, it has a phase-locked loop common to both oscillations for regulating the phases of both oscillations according to the method according to the first aspect using a regulation. In this way, the method can be implemented particularly efficiently, in particular as a hardware solution by means of a circuit, in particular an integrated circuit. With such a hardware-based implementation, high performance can in particular also be achieved.

In some embodiments, the control device further comprises: (i) an individual phase-locked loop for individually regulating each of the two oscillations; and (ii) a switching device for switching between the method modes. The control device is configured to regulate the phases of both oscillations according to the method according to the first aspect, insofar as this has the above-mentioned two method modes, and to use the individual phase-locked loop assigned to each oscillation in the first method mode and the common phase-locked loop in the second method mode to regulate the phases of both oscillations.

A third aspect of the present solution relates to a micro-scanner system with (i) at least one deflection element which can perform a first rotational oscillation about a first oscillation axis and with at least one deflection element which, simultaneously with the first oscillation, can perform a second rotational oscillation about a second oscillation axis which is not parallel to the first oscillation axis, in particular orthogonal to the first oscillation axis (and in particular can be the same deflection element as that which also performs the first oscillation) in order to effect a Lissajous projection into an observation field by reflective deflection of an electromagnetic beam incident on the micro-scanner system during the simultaneous oscillations; (ii) a drive device for driving the simultaneous oscillations; and (iii) a control device according to the second aspect for controlling the drive device.

In some embodiments, the deflection element of the micro-scanner forms a non-linear oscillator with respect to at least one of its oscillation axes, in particular a Duffing oscillator or an oscillator that can be described to a good approximation as a Duffing oscillator.

In particular, the control device can be configured to control the drive device at least for driving the non-linear oscillator in such a way that the temporal variation of the drive frequencies takes place in such a way that the frequency ratio is kept within a certain frequency ratio range, wherein the frequency range of the respective drive frequencies is below a frequency of the respective non-linear oscillator at which it reaches a maximum amplitude as the drive frequency increases. A lower limit of this frequency range can be in particular at the resonance frequency of the nonlinear oscillator (in free oscillation). This ensures that the advantages of a non-linear oscillator, in particular with regard to high amplitude and phase stability against fluctuations or shifts in the drive frequency or resonance frequency, in particular due to temperature, can be used, while hysteresis-related, undesirable amplitude and/or phase jumps, such as can occur at certain jump points in non-linear oscillators showing hysteresis, are avoided.

A fourth aspect of the present solution relates to a computer program or computer program product with instructions which, when executed on at least one processor of the control device according to the second aspect, cause the control device to carry out the method according to the first aspect for controlling a drive for a multi-axis micro-scanner system.

The computer program can in particular be stored on a non-volatile data carrier. Preferably the data carrier is in the form of an optical data carrier or a flash storage module. This can be advantageous if the computer program as such is to be handled independently of a processor platform on which the one or more programs are to be executed. In another implementation, the computer program can be present as a file on a data processing unit, in particular on a server, and can be downloaded via a data connection, for example the Internet or a dedicated data connection, such as a proprietary or local network. In addition, the computer program can have a plurality of interacting individual program modules. In particular, the modules can be configured or at least used in such a way that they are executed in the sense of distributed computing on different devices (such as computers or processor units) that are geographically remote from one another and connected to one another by a data network.

The micro-scanner system, in particular the control device, can accordingly have a program memory in which the computer program is stored. Alternatively, the micro-scanner system or control device can also be set up to access a computer program available externally, for example on one or more servers or other data processing units, via a communication connection, in particular in order to exchange data therewith, which data are used during the execution of the method or computer program or represent outputs of the computer program.

The features and advantages explained with respect to the first aspect of the invention also apply correspondingly to the further aspects of the invention.

Further advantages, features, and possible applications of the present invention result from the following description in more detail in conjunction with the figures.

In the figures:

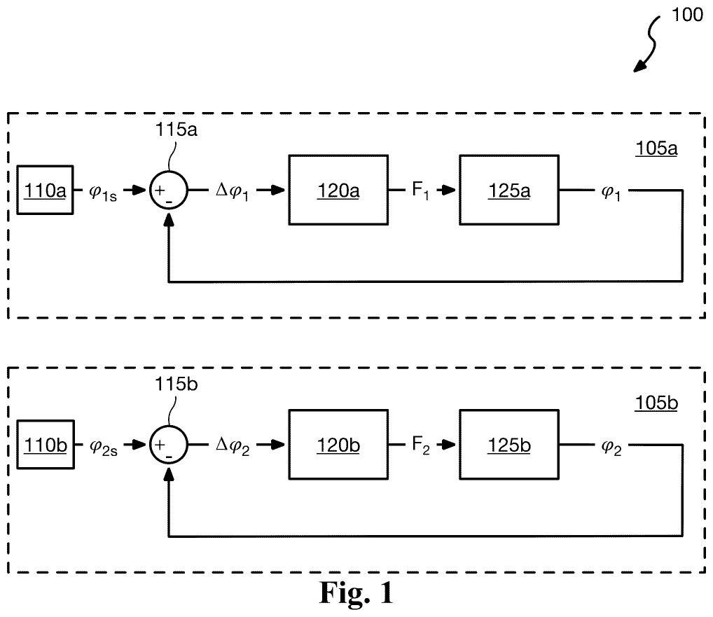

FIG. 1 shows schematically a conventional control device for driving a two-axis micro-scanner system, with separate phase controls for the two oscillation axes;

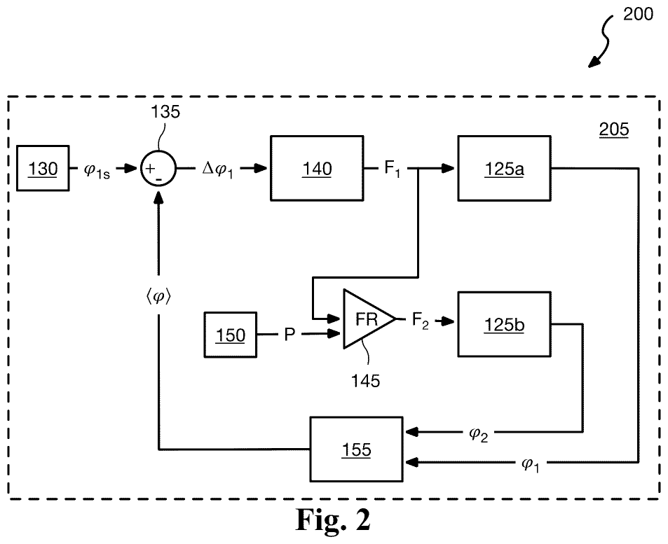

FIG. 2 schematically shows a first exemplary embodiment of a control device according to the present solution with a frequency ratio stabilizing combined phase-locked loop for both oscillation axes;

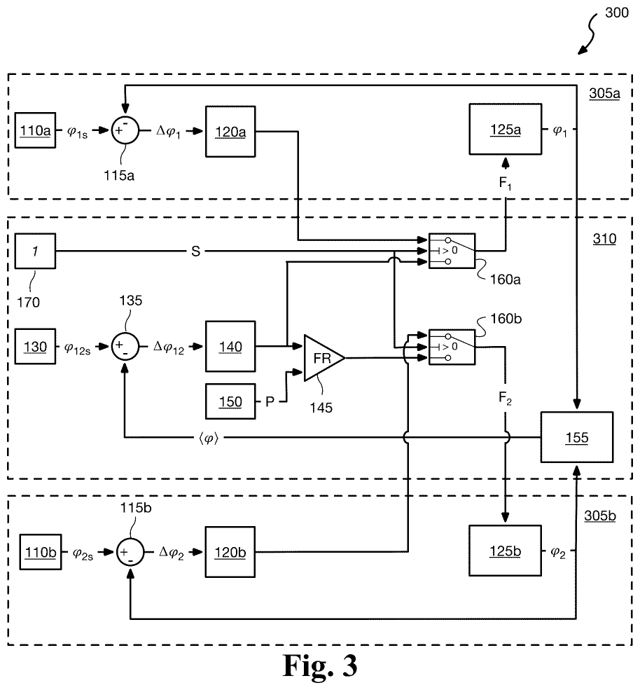

FIG. 3 schematically shows a second exemplary embodiment of a control device according to the present solution in which the phase loops from FIGS. 1 and 2 are combined to enable switching between two different method modes or operating modes of the control device;

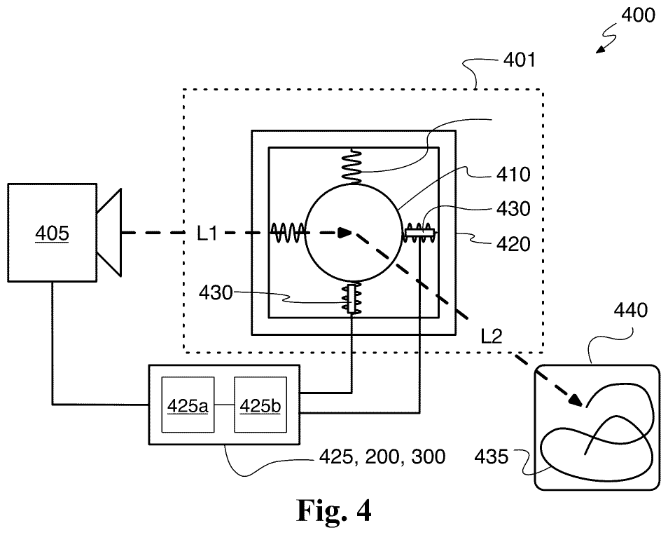

FIG. 4 schematically shows an exemplary embodiment of a micro-scanner system with a control device according to the solution, which can be implemented in particular with the aid of a computer program for carrying out the method according to the solution; and

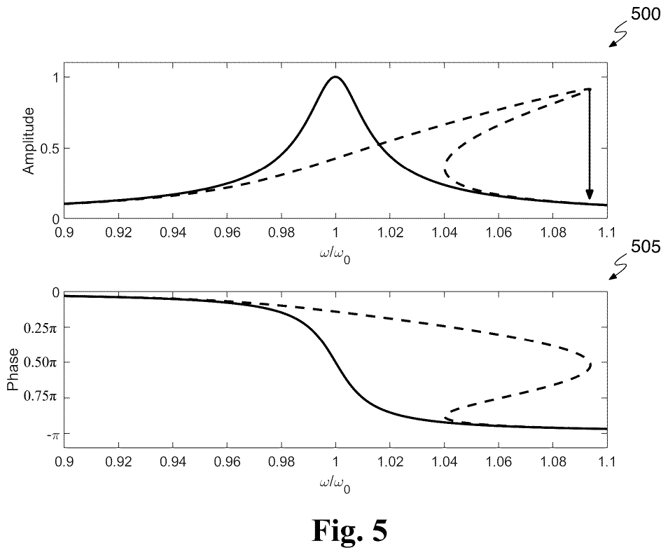

FIG. 5 shows an exemplary amplitude and phase response of a nonlinear oscillator, in particular a Duffing oscillator, each as a function of the angular frequency ω/ω₀ related to the resonant angular frequency woof the oscillator, with respect to an oscillation axis of a micro-scanner in comparison to corresponding amplitude and phase response for a harmonic oscillator.

In the figures, the same reference numerals denote the same, similar or corresponding elements. Elements depicted in the figures are not necessarily represented to scale. Rather, the various elements shown in the figures are presented in such a way that their function and general purpose can be understood by those skilled in the art. Connections and couplings, shown in the figures, between functional units and elements can also be implemented as an indirect connection or coupling, unless expressly stated otherwise. Functional units can be implemented in particular as hardware, software or a combination of hardware and software.

The conventional control device 100 shown in FIG. 1 for driving a two-axis micro-scanner system has two separate phase-locked loops (PLLs) 105a and 105b, one for each of the two oscillation axes of the micro-scanner system. In addition to the phase-locked loops 105a and 105b, the control device 100 can also have further components and circuits (not shown), for example for supplying power to the PLLs 105a and 105b.

The PLL 105a for the first oscillation axis has a source 110a, e.g. a storage device, for a reference variable in the form of a predetermined target phase position φ₁ₛ. A differential element 115a serves to determine a, typically time-dependent, regulation deviation Δφ₁ as the difference between an actual phase position φ₁ measured at the output of the PLL 105a and the target phase position φ₁ₛ and to feed it to a regulator 120a, e.g. a PI controller. The regulator 120a, in turn, serves to output a time-dependent control variable in the form of a drive frequency F₁ for the first oscillation axis to a drive device of the micro-scanner system for driving this oscillation axis, depending on the regulation deviation Δφ₁.

The drive device can in particular have one or more actuators, in particular piezo actuators, specifically assigned to this oscillation axis. The reference numeral 125a designates the regulation system of the PLL 105a, which does not itself belong to the control device and to which the micro-scanner with the first oscillation axis of the micro-scanner system belongs, including the drive device for this oscillation axis. By means of a sensor, in particular a piezo sensor, of the micro scanner system, the aforementioned actual phase position φ₁ with respect to the first oscillation axis is measured and fed to the differential element 115a via a feedback loop in order to close the regulation loop (“closed-loop”).

The PLL 105b for the second oscillation axis is constructed accordingly and thus has a source 110b for a reference variable in the form of a predetermined target phase position φ₂ₛ. Furthermore, a differential element 115b and a regulator 120b are provided in order to output a time-dependent control variable in the form of a drive frequency F₂ for the second oscillation axis to a drive device of the micro-scanner system for driving this second oscillation axis as a function of a regulation deviation Δφ₂ determined by the differential element 115b. The drive device can in particular have one or more actuators, such as piezo actuators, specifically assigned to this oscillation axis. It can also be combined with the drive device for the first oscillation axis to form a single unit. The reference numeral 125b designates here the regulation system of the PLL 105b, which does not itself belong to the control device and to which the micro-scanner with the second oscillation axis of the micro-scanner system belongs, including the drive device for this oscillation axis. By means of a sensor, in particular a piezo sensor, of the micro scanner system, the aforementioned actual phase position φ₂ with respect to the second oscillation axis is measured and fed to the differential element 115b via a feedback loop in order to close the phase locked loop 105b.

By means of the control device 100 it is possible to control the phases of the oscillations with respect to the two oscillation axes separately and independently of each other, in particular in such a way that the respective oscillation axis is kept in resonance. In this way, the largest possible oscillation amplitudes and thus deflection angles and resulting scan angles as well as high energy efficiency can be achieved.

In the first exemplary embodiment 200 of a control device according to the present solution shown in FIG. 2, a combined phase-locked loop (PLL) 205 is used for both oscillation axes. In addition to the phase-locked loop 205, the control device 200 can also have further components and circuits (not shown), for example for supplying power to the PLL 205. The following description of the first exemplary embodiment 200 also covers the method that can be carried out thereby for controlling a drive for a multi-axis micro-scanner system.

As with the PLL 105a for the first oscillation axis from FIG. 1, the phase-locked loop 205 also has a source 130, e.g. a storage device, for a reference variable in the form of a predetermined target phase position φ₁ₛ with respect to the first oscillation axis (alternatively to the second oscillation axis). A differential element 135 serves to determine a, typically time-dependent, regulation deviation Δφ₁ as the difference between an actual phase position φ₁ measured at the output of the PLL 205 and the target phase position φ₁ₛ and to feed it to a regulator 140, e.g. a PI regulator. The regulator 140 serves to output a time-dependent control variable in the form of a drive frequency F₁ for the first oscillation axis to a drive device of the micro-scanner system for driving this first oscillation axis, depending on the regulation deviation Δφ₁.

The drive device can in particular have in turn one or more actuators, in particular piezo actuators, specifically assigned to this oscillation axis. The reference numeral 125a designates here a regulation system of the PLL 205, which does not itself belong to the control device 200 for the first oscillation axis, and to which the micro-scanner with the first oscillation axis of the micro-scanner system belongs, including the drive device for this oscillation axis. By means of a sensor, in particular a piezo sensor, of the micro scanner system, the aforementioned actual phase position φ₁ with respect to the first oscillation axis is measured and fed via a feedback loop as a first input variable to a mean value calculation element 155.

The control variable F₁ is additionally fed to a frequency converter 145, which outputs a second control variable in the form of a drive frequency F₂ for the second oscillation axis from the control variable F₁ to a drive device of the micro-scanner system for driving this second oscillation axis. The frequency conversion takes place in such a way that a predetermined frequency ratio FR=F₁/F₂ results. This frequency ratio FR can be set via a parameterization P, which can be set on a configuration device 150, which can in particular be a human-machine interface, and in particular can be selected from various predefined options.

The drive device for the second oscillation axis also can in particular have in turn one or more actuators, in particular piezo actuators, specifically assigned to this oscillation axis. The reference numeral 125b designates here a regulation system of the PLL 205, which does not itself belong to the control device 200 for the second oscillation axis, and to which the micro-scanner with the second oscillation axis of the micro-scanner system belongs, including the drive device for this oscillation axis. By means of a sensor, in particular a piezo sensor, of the micro scanner system, the aforementioned actual phase position 2 with respect to the second oscillation axis is measured and fed via a feedback loop as a second input variable to the mean value calculation element 155.

The mean value calculation element 155 calculates the mean value [symbol] φ [symbol] from the two actual phase positions φ1 and φ2 fed to it as input variables and returns it to the differential element 135 in order to close the feedback loop of the PLL 205. Overall, the PLL 205 thus represents a phase-locked loop in which the frequency ratio FR is kept stable within the scope of the regulation, even if the actual phase positions φ₁ and φ₂ change in such a way that the drive frequencies F₁ and F₂ are subsequently detuned by the regulator 140.

The output of the regulator 140 acts equally on both axes, wherein the two drive frequencies F₁ and F₂ are coupled to each other via a fixed frequency ratio (for a given parameterization P). Thus, the temporal variation of the drive frequencies can be carried out in such a way that at the same time a change in the frequency ratio FR between the two drive frequencies F₁ and F₂ is counteracted by the regulation. In this way, a Lissajous figure that remains essentially constant, at least over a longer observation period, is made possible. By averaging the measured actual phase positions φ₁ and φ₂, both oscillation axes are given equal weight during regulation.

Instead of the controller, a frequency control (“open-loop”) can also be provided, which then adjusts both frequencies proportionally, so that here too the frequency ratio FR remains stable or a change in it is counteracted by the proportional control.

In the second exemplary embodiment 300 of a control device according to the present solution shown in FIG. 3, the phase loops from FIGS. 1 and 2 are combined in order to enable switching between two different method modes or operating modes of the control device. The following description of the first exemplary embodiment 300 also covers the method that can be carried out thereby for controlling a drive for a multi-axis micro-scanner system.

The control device 300 therefore has a first PLL 305a for the first oscillation axis, a second PLL 305b for the second oscillation axis, and a combined PLL 310 as circuit components. The combined PLL 310 receives as a reference variable a target value φ₁₂ₛ for the mean value of the phase positions of both oscillation axes. In order to enable switching between the two method modes or operating modes, two switches 160a and 160b are provided, each of which can be controlled via a switching signal S generated by a signal generator 170. Here it is shown by way of example that the switches 160a and 160b are switched over when the signal s has a signal value greater than “0”, i.e. a value “1” in the digital (binary) case.

In a first switch position (as shown in FIG. 3), the two PLLs 305a and 305b as well as the two control loops 125a and 125b are decoupled from the combined PLL 310. This switch position corresponds to a first method mode or operating mode of the control device, which corresponds to that of FIG. 1, where the two drive frequencies F₁ and F₂ are regulated independently of each other by their associated PLL 305a or 305b. This first mode can be used in particular for ramping up the micro-scanner system when it is started up or when it is restarted after a fault, since the focus here is less on high image quality and more on carrying out the swinging in processes of the oscillations quickly and efficiently.

The other, second switch position, which can be reached by switching, corresponds to a second method mode or operating mode of the control device, which corresponds to that of FIG. 2, where the combined PLL 310 is used. In this mode, as previously explained in detail with reference to FIG. 2, a regulation takes place in such a way that a stable frequency ratio FR is set between the two drive frequencies F₁ and F₂ and each of the control loops 125a and 125b is supplied with the respective associated drive frequency F₁ or F₂ resulting from this regulation as a control variable, in particular in the form of a drive signal having this respective drive frequency F₁ or F₂ for the respective drive device (e.g. piezo actuator(s)).

FIG. 4 schematically shows a two-axis micro-scanner system according to an exemplary embodiment 400 of the present invention, which can be used in particular for projecting images or image sequences (e.g., moving images, videos, etc.). The micro-scanner system 400 includes a radiation source 405, which can in particular be a laser source, wherein the wavelength of the emitted radiation L₁ can be in particular in the visible spectral range, although depending on the application, other spectral ranges can also be used, for example in the context of methods for material inspection. In the following, unless otherwise stated, it is assumed by way of example that the radiation L₁ is emitted as a laser beam in the visible spectral range.

The laser beam L₁ is directed at a micro-scanner 401 which has a deflection element 410 in the form of a mirror plate suspended by two crossed spring pairs 415, which each define an oscillation axis, at a surrounding frame 420. At the deflection element 410, the beam L₁ is reflected (mirrored) in the sense of optical imaging and directed as a reflected beam L₂ onto a projection surface 440 in the observation field of the micro-scanner 401.

The micro-scanner system 400 furthermore includes a control device 425, which is configured to supply the radiation source with at least one modulation signal, depending on which the laser beam is modulated. The modulation can particularly affect its temporal or local intensity profile. However, depending on the type of radiation source, other types of modulation are also conceivable, in particular modulations of the wavelength (for example color) or wavelength distribution of the radiation emitted by the radiation source 405. When projecting images, the modulation accordingly takes place depending on the current deflection direction, so that corresponding image points on the projection surface having the associated pixel value of the corresponding image point of the image to be displayed are generated by modulation.

The control device 425 is furthermore configured to control a drive device of the micro-scanner 401 in order for it to cause the drive of simultaneous oscillations of the deflection element 410 of the micro-scanner 401 about its two oscillation axes according to the inventive method so that the light or radiation point generated by the reflected beam L₂ on the projection surface 440 runs along a trajectory or path in the form of a trajectory-regulated Lissajous FIG. 435, which completely illuminates an area on the projection surface intended as an image surface already within a short time interval. In the case of a projection of a digital image made up of pixels, this means that all pixels are reached or displayed by the trajectory during observation time. The drive device can in particular have at least one actuator, in particular piezo actuator 430. In FIG. 4, two piezo actuators 430 are shown as an example according to a conceivable embodiment, each mounted on one of the springs 415 per spring pair A further such piezo actuator 430 can also be provided on the other two springs 415.

The control device 425 has a phase regulation for each oscillation axis for stabilizing a frequency ratio between the drive frequencies F₁ and F₂ of the two oscillation axes. The control device can in particular correspond to or have the embodiment 200 from FIG. 2 or the embodiment 300 from FIG. 3.

However, instead of such a hardware-based implementation, a software-based implementation is also possible (as shown in FIG. 4). To this end, the control device 425 can in particular have a data processing device 425a with one or more processors and a storage device 425b. In particular, a computer program can be stored in the storage device 425b, which program is configured to cause the control device 425 to execute the method when it runs on the data processing device or its at least one processor. In particular, the combined regulation of the two drive frequencies F₁ and F₂ can be implemented entirely or partially in this form by software. In addition, the storage device can be used to store the current setting of the parameterization P (see FIG. 2 or 3).

However, the micro-scanner system 400 is also operable in the opposite direction, so that radiation emitted or reflected by an object to be observed is scanned by means of a Lissajous figure and in this case reflected on the corresponding oscillating deflection element 410 and imaged in the direction of the unit 405, where a sensor device can then be located, in particular an image sensor, in order to sensor-detect the radiation, in addition or instead of a laser source.

FIG. 5 shows in respective diagrams 500 and 505 an exemplary amplitude response and phase response (curves drawn in dashed lines) of a non-linear oscillator, in particular a so-called Duffing oscillator (in which a cubic restoring force is present instead of the restoring force which is linearly dependent on the deflection according to Hooke's law), each as a function of the drive circuit frequency ω/ω₀ related to the resonant circuit frequency ω₀ of the oscillator, in comparison to corresponding amplitude and phase response (curves drawn in solid lines) for a harmonic oscillator.

Such an amplitude and phase response can occur in particular with respect to an oscillation of a deflection element about an oscillation axis of a micro-scanner, with respect to which the deflection element with its suspension forms such a nonlinear oscillator. Related to the above examples with the drive frequencies F₁ and F₂, depending on the oscillation axis considered the following applies: ω=2π·F₁ or ω=2π·F₂.

Examples of nonlinear oscillators in micro-scanners can be found in particular in DE 10 2020 116 511. These include, in particular, two-dimensional micro-scanners with coupled oscillation axes, as micro-scanners in which a non-negligible interaction occurs between the oscillations with respect to two orthogonal oscillation axes of the deflection element of the micro-scanner.

While the amplitude response of the harmonic oscillator shown for comparison, illustrated in diagram 500, has a relatively sharply defined maximum at its resonant frequency ω₀ or equivalently at ω/ω₀=1, the nonlinear oscillator, depending on the coefficients of the nonlinear terms of the corresponding oscillation equation, has a less steep overhang, in the present case towards higher frequencies, so that in the area of the overhang the amplitude values depend on whether the overhang area is approached from lower or higher frequencies. This results in hysteresis. Overall, the maximum is asymmetrical to the resonant frequency ω₀ and is broader than in the harmonic oscillator, where the corresponding frequency range with the highest amplitude values (e.g. above 90% of the maximum value) is narrower and lies symmetrically around the maximum at the resonant frequency ω₀.

As can be seen from the lower diagram in FIG. 5, in the non-linear oscillator, a flattening and shift of the phase transition to phases with opposite sign only occurs at higher drive circuit frequencies ω (with ω/ω₀>1) than in the harmonic oscillator. The value of the phase at the reversal point of the (dashed) phase curve is always π/2.

Such a nonlinear oscillator, in particular in the form of a deflection element of a micro-scanner, is thus more robust in terms of its amplitude and phase against small (in particular temperature-dependent) fluctuations or shifts in the ratio ω/ω₀, be it through a corresponding change in the resonant circuit frequency ω₀ and/or the drive circuit frequency a, than an otherwise comparable harmonic oscillator in a frequency range lying around ω/ω₀=1 and thus used in particular in resonantly operated micro-scanners.

However, in order to avoid amplitude jumps in the oscillation, it is useful to implement a limitation of the frequency of the nonlinear oscillator so that the ratio ω/ω₀ does not reach the jump point at the end of the overhang, where a discontinuity (jump) occurs in the curve (see arrow). This can be achieved in particular by a corresponding limitation or definition of the drive circuit frequency ω/ω₀, wherein its typical fluctuation range is or should be taken into account within the framework of a respective implementation.

While at least one exemplary embodiment has been described above, it is to be noted that a large number of variations thereto exist. It is also to be noted that the exemplary embodiments described only represent non-limiting examples, and are not intended to restrict the scope, the applicability, or the configuration of the devices and methods described herein. Rather, the preceding description will provide those skilled in the art with guidance for implementing at least one exemplary embodiment, wherein it is apparent that various changes in the operation and arrangement of elements described in an exemplary embodiment may be made without departing from the scope of the subject matter defined in the appended claims and their legal equivalents.

### LIST OF REFERENCE NUMERALS

100 conventional control device for driving a two-axis micro-scanner system
105a individual phase-locked loop (PLL) for the first oscillation axis
105b individual phase-locked loop (PLL) for the second oscillation axis
110a source of a reference variable for the PLL 105a
110b source of a reference variable for the PLL 105b
115a differential element of the PLL 105a
115b differential element of the PLL 105b
120a regulator of the PLL 105a
120b regulator of the PLL 105b
125a regulation system for the first oscillation axis
125b regulation system for the second oscillation axis
130 source of a reference variable for the PLL 205
135 differential element of the PLL 205
140 regulator of the PLL 205
145 frequency converter
150 configuration apparatus
155 mean value calculation element
160a, b switch
200 first embodiment of a control device
205 combined PLL of the first embodiment 200
300 second embodiment of a control device
305a individual phase-locked loop (PLL) for the first oscillation axis
305b individual phase-locked loop (PLL) for the second oscillation axis
310 combined phase-locked loop (PLL) for both oscillation axes
400 micro-scanner system
401 two-axis micro-scanner
405 radiation source
410 deflection element
415 pairs of springs
420 frame
425 control device
425a data processing device
425b storage device
430 piezo actuator
435 Lissajous figure or Lissajous trajectory
440 projection surface
500 diagram of frequency-dependent amplitude responses
505 diagram of frequency-dependent phase responses
F₁ drive frequency for the first oscillation axis
F₂ drive frequency for the second oscillation axis
FR frequency ratio of the drive frequencies of both oscillation axes
P parameterization for setting the frequency ratio FR
φ₁ₛ reference variable (target phase position) for the first oscillation axis
φ₂ₛ reference variable (target phase position) for the second oscillation axis
Δφ₁ regulation deviation for the first oscillation axis
Δφ₂ regulation deviation for the second oscillation axis
φ₁ actual phase position for the first oscillation axis
φ₂ actual phase position for the second oscillation axis
φ₁₂ₛ reference variable (target phase position) for the mean value of the phase positions of both oscillation axes
[symbol] φ [symbol] mean value of the actual phase positions φ₁ and φ₂
L₁ incident (laser) beam
L₂ reflected (laser) beam
ω drive circuit frequency
ω₀ resonance frequency

What is claimed is:

1. A method for controlling a drive for a multi-axis micro-scanner system, the method comprising:
controlling a drive device for the micro-scanner system such that
the micro-scanner system is caused to drive a first rotational oscillation of a deflection element of the micro-scanner system about a first oscillation axis by means of excitation at a first drive frequency (F₁) and, simultaneously with the first oscillation, a second rotational oscillation of a deflection element of the micro-scanner system about a second oscillation axis which is not parallel to the first oscillation axis, by means of excitation at a second drive frequency (F₂), wherein these drive frequencies (F₁, F₂) are each varied in time; and
varying the drive frequencies (F₁, F₂) over time in such a way that a change in the frequency ratio between the two drive frequencies is counteracted at the same time.

2. The method according to claim 1, wherein the frequency ratio is a variable that can be set by means of at least one parameterization of the control, and the method further comprises setting this variable to a target value.

3. The method according to claim 2, wherein the setting of this variable to a target value occurs while the oscillations are driven by the drive device.

4. The method according to claim 1, wherein the counteraction against a change in the frequency ratio between the two drive frequencies, at least in a steady state of the two oscillations, is carried out in such a way that the frequency ratio is kept in a range of ±1%, in particular in a range of ±0.01%, and preferably in a range of +0.001%, of its initial value at the beginning of the temporal variation of the drive frequencies (F₁, F₂).

5. The method according to claim 1, wherein the control of the drive device comprises a regulation of the oscillations, wherein the temporal variation of the drive frequencies (F₁, F₂) is carried out in such a way that at the same time a change in the frequency ratio between the two drive frequencies (F₁, F₂) is counteracted by means of the regulation.

6. The method according to claim 5, wherein for regulation a regulation variable is used which
depends both on a first sensor-detected value of at least one physical variable which is in a dependency relationship with a resonance frequency of the first oscillation axis,
and on a second sensor-detected value of at least one second physical variable which is in a dependency relationship with a resonance frequency of the second oscillation axis.

7. The method according to claim 6, wherein the first physical variable and/or the second physical variable characterizes or depends on one of the following states of the micro-scanner system or a combination of at least two of these states or state changes:
a shift of a measured resonance frequency of at least one of the oscillations;
a temperature;
a mechanical stress or strain;
an oscillation amplitude of the or a deflection element;
a phase instability occurring in at least one of the oscillations;
a respective control variable of a phase-locked loop for the phase of at least one of the oscillations;
a phase difference (Δφ₁; Δφ₂) between a drive signal for controlling the drive device and a measurement signal (φ₁; φ₂), which represents a measured deflection of the deflection element;
a change in the incident electromagnetic radiation power which the deflection element receives by absorption;
a change in an oscillation state of a reference oscillator in the micro-scanner system which is correlated with an oscillation state of the or at least one deflection element.

8. The method according to claim 6, wherein the regulation variable is determined by means of an averaging or a bad point regulation from the first physical variable and the second physical variable as input variables.

9. The method according to claim 1, wherein the method comprises:
a first method mode in which the drive device is controlled such that the first oscillation and the second oscillation are regulated independently of one another; and
a second method mode in which the drive device is controlled by the controlling of the drive device and the varying of the drive frequencies;
wherein, in the method, switching between the two method modes takes place.

10. The method according to claim 9, wherein the first method mode is used to start the oscillations from a resting state or when an occurrence of a disturbance of at least one of the oscillations has been detected, and the switching from the first method mode to the second method mode takes place when it is subsequently detected that the two oscillations are in a respective steady state.

11. The method according to claim 1, wherein the deflection element of the micro-scanner system forms a non-linear oscillator with respect to at least one of its oscillation axes, and the temporal variation of the drive frequencies (F₁, F₂) occurs such that the frequency ratio is kept within a certain frequency ratio range, wherein the frequency range of the respective drive frequencies (F₁, F₂) is below a frequency of the respective non-linear oscillator at which it reaches a maximum amplitude with increasing drive frequency.

12. A control device for controlling a drive for a multi-axis micro-scanner system, wherein the control device is configured to carry out the method according to claim 1.

13. The control device according to claim 12, comprising a phase-locked loop common to both oscillations for regulating the phases of both oscillations according to a method comprising:
controlling a drive device for the micro-scanner system such that
the micro-scanner system is caused to drive a first rotational oscillation of a deflection element of the micro-scanner system about a first oscillation axis by means of excitation at a first drive frequency (F₁) and, simultaneously with the first oscillation, a second rotational oscillation of a deflection element of the micro-scanner system about a second oscillation axis which is not parallel to the first oscillation axis, by means of excitation at a second drive frequency (F₂), wherein these drive frequencies (F₁, F₂) are each varied in time; and
varying the drive frequencies (F₁, F₂) over time in such a way that a change in the frequency ratio between the two drive frequencies is counteracted at the same time, wherein the control of the drive device comprises a regulation of the oscillations, wherein the temporal variation of the drive frequencies (F₁, F₂) is carried out in such a way that at the same time a change in the frequency ratio between the two drive frequencies (F₁, F₂) is counteracted by means of the regulation.

14. The control device according to claim 13, wherein the control device further comprises:
a respective individual phase-locked loop for respectively individually controlling the two oscillations; and
a switching device for switching between the method modes;
wherein the control device is configured to regulate the phases of both oscillations by a first method mode in which the drive device is controlled such that the first oscillation and the second oscillation are regulated independently of one another and a second method mode in which the drive device is controlled by the controlling of the drive device and the varying of the drive frequencies, wherein the switching between the two method modes takes place and to use the individual phase-locked loop assigned to each oscillation in the first method mode for regulating the phases of both oscillations and to use the common phase-locked loop in the second method mode.

15. A micro-scanner system with at least one deflection element, which can carry out a first rotational oscillation around a first oscillation axis and with at least one deflection element which can carry out a second rotational oscillation around a second oscillation axis which is not parallel to the first oscillation axis, simultaneously with the first oscillation, in order to cause a Lissajous projection in an observation field by reflective deflection of an electromagnetic beam (L₁) incident on the micro-scanner system during the simultaneous oscillations;
a drive device for driving the simultaneous oscillations; and
a control device according to claim 11 for controlling the drive device.

16. The micro-scanner system according to claim 15, wherein the deflection element forms a non-linear oscillator with respect to at least one of its oscillation axes.

17. The micro-scanner system according to claim 16, wherein the control device is configured to control the drive device at least for driving the non-linear oscillator according to a method comprising:
controlling a drive device for the micro-scanner system such that
the micro-scanner system is caused to drive a first rotational oscillation of a deflection element of the micro-scanner system about a first oscillation axis by means of excitation at a first drive frequency (F₁) and, simultaneously with the first oscillation, a second rotational oscillation of a deflection element of the micro-scanner system about a second oscillation axis which is not parallel to the first oscillation axis, by means of excitation at a second drive frequency (F₂), wherein these drive frequencies (F₁, F₂) are each varied in time; and
the drive frequencies (F₁, F₂) are varied over time in such a way that a change in the frequency ration between the two drive frequencies is counteracted at the same time, wherein the deflection element of the micro-scanner system form aa non-linear oscillator with respect to at least one of its oscillation axes and the temporal variation of the drive frequencies (F₁, F₂) occurs such that the frequency ratio is kept within a certain frequency ratio range, wherein the frequency range of the respected drive frequencies (F₁, F₂) is below a frequency of the respective non-linear oscillator at which it reaches a maximum amplitude with increasing drive frequency.

18. A computer program or computer program product with instructions which, when executed on at least one processor of the control device according to claim 12, cause the control device to carry out a method for controlling a drive for a multi-axis micro-scanner system, in particular a micro-scanner system, the method comprising:
controlling a drive device for the micro-scanner system such that
the micro-scanner system is caused to drive a first rotational oscillation of a deflection element of the micro-scanner system about a first oscillation axis by means of excitation at a first drive frequency (F₁) and, simultaneously with the first oscillation, a second rotational oscillation of a deflection element of the micro-scanner system about a second oscillation axis which is not parallel to the first oscillation axis, by means of excitation at a second drive frequency (F₂), wherein these drive frequencies (F₁, F₂) are each varied in time; and
the drive frequencies (F₁, F₂) are varied over time in such a way that a change in the frequency ration between the two drive frequencies is counteracted at the same time, wherein the micro-scanner system comprises: at least one deflection element, which can carry out a first rotational oscillation around a first oscillation axis, and at least one deflection element, which can carry out a second rotational oscillation around a second oscillation axis which is not parallel to the first oscillation axis, simultaneously with the first oscillation, in order to cause a Lissajous projection in an observation field by reflective deflection of an electromagnetic beam (L₁) incident on the micro-scanner system during the simultaneous oscillations; a drive device for driving the simultaneous oscillations; and a control drive for controlling the drive device, wherein the deflection element of the micro-scanner system forms a non-linear oscillator with respect to at least one of its oscillation axes, and the temporal variation of the drive frequencies (F₁, F₂) occurs such that the frequency ratio is kept within a certain frequency ration range, wherein the frequency range of the respective drive frequencies (F₁, F₂) is below a frequency of the respective non-linear oscillator at which it reaches a maximum amplitude with increasing drive frequency.

19. The method according to claim 7, wherein the regulation variable is determined by means of an averaging or a bad point regulation from the first physical variable and the second physical variable as input variables.

20. The method according to claim 2, wherein the method comprises:
a first method mode in which the drive device is controlled such that the first oscillation and the second oscillation are regulated independently of one another; and
a second method mode in which the drive device is controlled according to claim 2;
wherein, in the method, switching between the two method modes takes place.
